(19) United States
(12) Patent Application Publication
(10) Pub. No.: US 2024/0132090 A1
(43) Pub. Date: Apr. 25, 2024

(54) VEHICLE CONTROLLER AND RECORDING MEDIUM

(71) Applicant: Toyota Jidosha Kabushiki Kaisha, Toyota-shi Aichi (JP)

(72) Inventors: Shigeki Nakayama, Gotenba-shi Shizuoka-ken (JP); Tomohiro Kaneko, Mishima-shi Shizuoka-ken (JP); Kotoru Sato, Hadano-shi Kanagawa-ken (JP)

(73) Assignee: Toyota Jidosha Kabushiki Kaisha, Toyota-shi Aichi (JP)

(21) Appl. No.: 18/478,319

(22) Filed: Sep. 28, 2023

(30) Foreign Application Priority Data
Oct. 20, 2022 (JP) 2022-169364

(51) Int. Cl. B60W 50/12; B60W 40/09; B60W 40/107; B60W 50/00; G06V 10/70; G06V 20/59

(52) U.S. Cl. CPC B60W 50/12; B60W 40/09; B60W 40/107; B60W 50/0098; G06V 10/70; G06V 20/597; B60W 2420/42; B60W 2520/105; B60W 2540/22

(57) ABSTRACT

A vehicle controller for a vehicle includes a processor to: detect a driving state of the vehicle; determine whether a predetermined dangerous driving is included in the detected driving state; determine, when determining that the predetermined dangerous driving is included in the detected driving state, whether a mood of a driver of the vehicle is elevated; and perform, when determining that the mood of the driver is elevated, vehicle control to settle the mood of the driver.

### CROSS-REFERENCE TO RELATED APPLICATION (S)

The present application claims priority to and incorporates by reference the entire contents of Japanese Patent Application No. 2022-169364 filed in Japan on Oct. 21, 2022.

### BACKGROUND

The present disclosure relates to a vehicle controller and a recording medium.

Japanese Laid-open Patent Publication No. 2017-136922 estimates the emotion of the driver or passenger, a technique for controlling the travel of the vehicle based on the estimation result is disclosed.

### SUMMARY

There is a need for providing a vehicle controller and a recording medium storing a vehicle control program capable of shifting to a safe driving state even when the mood of the driver is elevated.

According to an embodiment, a vehicle controller for a vehicle includes a processor to: detect a driving state of the vehicle; determine whether a predetermined dangerous driving is included in the detected driving state; determine, when determining that the predetermined dangerous driving is included in the detected driving state, whether a mood of a driver of the vehicle is elevated; and perform, when determining that the mood of the driver is elevated, vehicle control to settle the mood of the driver.

According to an embodiment, a non-transitory computer-readable recording medium stores a program for causing a processor of a vehicle controller to: detect a driving state of the vehicle; determine whether a predetermined dangerous operation is included in the detected driving state; determine, when determining that the predetermined dangerous operation is included in the detected driving state, whether a mood of a driver of the vehicle is elevated; and perform, when determining that the mood of the driver is elevated, vehicle control to settle the mood of the driver.

### BRIEF DESCRIPTION OF THE DRAWINGS

FIG. 1 is a block diagram illustrating a schematic configuration of a vehicle control apparatus according to the embodiment;

FIG. 2 is a diagram illustrating a flow of information in each part of the vehicle control apparatus according to the embodiment;

FIG. 3 is a flowchart illustrating an example of a processing procedure of a vehicle control method that is executed by the vehicle controller according to the embodiment; and

FIG. 4 is a flowchart illustrating an example of a processing procedure of a vehicle control method that is executed by the vehicle controller according to the embodiment.

### DETAILED DESCRIPTION

In Japanese Laid-open Patent Publication No. 2017-136922, it is possible, for example, to create a learned model by machine learning, perform vehicle control using the learned model. Then, when the vehicle is performing dangerous driving, it is conceivable to automatically intervene in the driving operation. However, when the driver's mood is elevated, forcible intervention in the driving operation may increase the reaction to the intervention and may rather induce a hazard. Therefore, a technology is desired capable of shifting to a safe driving state even when the mood of the driver was elevated.

Vehicle control apparatus and a vehicle control program stored in a recording medium according to an embodiment of the present disclosure will be described with reference to the drawings. In addition, components in the following embodiments include those which can be substituted and easily by those skilled in the art, or those which are substantially the same.

Vehicle Controller

A vehicle controller 1 is for controlling the vehicle. The vehicle controller 1 may be mounted on the vehicle, or may be realized by a different server device or the like from the vehicle. In the present embodiment will be described on the assumption that the vehicle controller 1 is mounted on the vehicle.

Incidentally, when the vehicle controller 1 is realized by the server device, for example, the Internet line network, the vehicle and the server device is connected by a network comprising a mobile phone line network or the like. Then, the server device that is the vehicle controller 1 remotely controls the vehicle by communicating through the communication unit (Data Communication Module: DCM) of the vehicle.

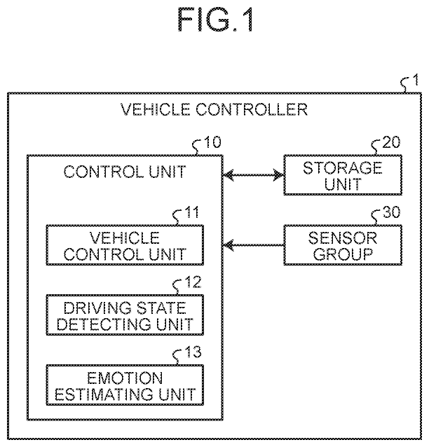

The vehicle controller 1 includes, as illustrated in FIG. 1, a control unit 10, a storage unit 20, and a sensor group 30. The control unit 10 includes a processor, and a memory (main storage unit). The processor is specifically composed of a Central Processing Unit (CPU), a Digital Signal Processor (DSP), a Field-Programmable Gate Array (FPGA), a Graphics Processing Unit (GPU), etc. The memories consist of a Random Access Memory (RAM) and a Read Only Memory (ROM).

The control unit 10 loads and executes the program stored in the storage unit 20 in the work area of the main storage unit, by controlling each configuration unit or the like through the execution of the program, to realize a function that meets a predetermined purpose. The control unit 10 functions as the vehicle control unit 11, the driving state detecting unit 12, and the emotion estimating unit 13 through execution of the program stored in the storage unit 20.

Vehicle control unit 11 performs a vehicle control for settling the mood of the lifted driver (first vehicle control) and a vehicle control for avoiding dangerous driving of the vehicle (second vehicle control). It will be described below specific contents of these controls.

First Vehicle Control

The vehicle control unit 11, for example, is determined to include a predetermined dangerous driving by the driving state detecting unit 12, and when it is determined that the mood of the driver of the vehicle is elevated by the emotion estimating unit 13, to perform the vehicle control to settle the mood of the driver. In this case, the vehicle control unit 11, without performing the vehicle control intervening in the vehicle operation of the driver (prohibited), to implement a vehicle control to settle the mood of the driver. Thus, before intervening in the vehicle operation of the driver, by settling the mood of the driver, it is possible to suppress the reaction of the driver to the intervention to the vehicle operation is increased.

Examples of the predetermined dangerous driving include, for example, excessive inter-vehicle packing, excessive vehicle speed, excessive acceleration, and thrust driving. Further, as the vehicle control to settle the mood of the driver, for example, control for adjusting the comfortable temperature by controlling the air conditioning of the vehicle, a control for releasing a comfortable scent by controlling the scent generating device and the like. Further, the vehicle control to settle the mood of the driver, for example, control to flow the news by controlling the audio device, the remarks to settle the mood by controlling the audio device, control to reproduce the comfort and the like, a control to flow comfortable music by controlling the audio device and the like. Incidentally, when performing these controls, information such as temperature, talk, music, and fragrance may be collected in advance.

Further, when, for example, it is determined by the driving state detecting unit 12 that a predetermined dangerous driving is not detected, the vehicle control unit 11 may further determine whether the amount of change in acceleration of the vehicle is deviated from a predetermined amount of change in acceleration of the vehicle based on the driving state detected by the driving state detecting unit 12. Then, when determining that the amount of change in acceleration of the vehicle is deviated from the predetermined amount of change in acceleration of the vehicle, the vehicle control unit 11 may further determine whether the mood of the driver is raised by the emotion estimating unit 13. When determining that the mood of the driver is raised, the vehicle control unit 11 may perform the vehicle control for settling the mood of the driver. Thus, even in a situation where the dangerous driving is not detected, when the acceleration is gradually larger and coarser than in normal times, the occurrence of the dangerous driving can be suppressed beforehand by settling in advance of the mood of the driver.

Further, for example, when a predetermined dangerous driving is not detected by the driving state detecting unit 12, but it is determined that the mood of the driver of the vehicle is elevated by the emotion estimating unit 13, the vehicle control unit 11 may perform control to settle the mood of the driver. Thus, even in a situation where the dangerous driving is not detected, the occurrence of the dangerous driving can be suppressed beforehand by settling the mood of the driver when the mood of the driver is high.

Second Vehicle Control

For example, in the case of implementing the vehicle control to settle the mood of the driver, when it is determined that the dangerous driving is continued or deteriorated for a predetermined time by the driving state detecting unit 12, the vehicle control unit 11 performs vehicle control intervening in the vehicle operation of the driver. In this case, the vehicle control unit 11 suspends the vehicle control (determination of the mood height-vehicle control) to settle the mood of the driver (without performing), and forcibly executes the vehicle control intervening in the vehicle operation of the driver.

The vehicle control intervening in the vehicle operation of the driver, for example, indicates a control such that does not respond directly to the vehicle operation of the driver. The vehicle control intervening in the driver's vehicle operation includes, for example, control so as not to accelerate even if the accelerator is pressed, control so as to automatically reduce the vehicle speed and increase the distance between the vehicle and the preceding vehicle, and the like. Thus, when the mood of the driver cannot be settled and the dangerous driving is continued, the occurrence of an accident or the like can be suppressed by forcibly intervening in the vehicle operation of the driver.

In addition, the vehicle control unit 11 may perform the vehicle control to intervene in the vehicle operation of the driver, for example, in a case where the vehicle control to settle the mood of the driver is performed, when it is determined that the elevation of the mood of the driver is not accommodated by the emotion estimating unit 13. Thus, when it is impossible to settle the mood of the driver, it is possible to suppress the occurrence of accidents and the like by forcibly intervening in the vehicle operation of the driver.

Further, the vehicle control unit 11 may perform, for example, the vehicle control to settle the mood of the driver a plurality of times at predetermined intervals. Further, in a case where the vehicle control to settle the mood of the driver is performed a predetermined number of times, but it is determined that the elevation of the mood of the driver is not accommodated by the emotion estimating unit 13, the vehicle control unit 11 may perform the vehicle control to intervene in the vehicle operation of the driver. Thus, even when the vehicle control to settle the mood of the driver is performed the predetermined number of times, but it is not possible to settle the mood of the driver, it is possible to suppress the occurrence of an accident or the like by forcibly intervening in the vehicle operation of the driver.

The vehicle control unit 11 may perform the above-described vehicle control (second vehicle control) on the basis of a learned model previously learned by machine learning or a predetermined rule. In the case of using the learned model, the input data is, for example, a detection result (determination result with dangerous driving) by the driving state detecting unit 12 and an emotion estimation result (determination result with elevated mood) by the emotion estimating unit 13. Then, the output data is, for example, a control amount of acceleration or vehicle speed.

The method of constructing a learned model used in the vehicle control unit 11 is not particularly limited, and various machine learning methods such as a deep learning using a neural network, a support vector machine, a decision tree, a simple Bayesian, and a k-neighborhood method may be used.

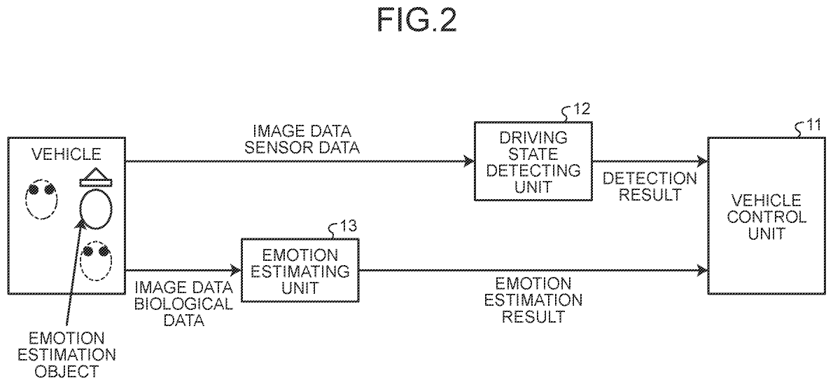

The driving state detecting unit 12 detects the driving state of the vehicle. The driving state detecting unit 12, as illustrated in FIG. 2, for example, acquires the image data of the surroundings of the vehicle from the camera of the sensor group 30. Alternatively, the driving state detecting unit 12, for example, acquires the sensor data around the vehicle from the in-vehicle sensor of the sensor group 30. Subsequently, the driving state detecting unit 12 detects the driving state of the vehicle based on the acquired image data or sensor data.

Subsequently, the driving state detecting unit 12 determines whether a predetermined dangerous driving is included in the detected driving state, and outputs the determination result to the vehicle control unit 11. The dangerous operation which the driving state detecting unit 12 includes, in this case, for example, the followings:

(1) The distance between the vehicle and the preceding vehicle is smaller than the predetermined threshold value (too much space between vehicles).

(2) The vehicle speed is higher than a predetermined threshold value (vehicle speed is too high).

(3) The acceleration is greater than the predetermined threshold value (acceleration is too high).

(4) Inciting (inciting driving) against the surrounding vehicle.

Further, in a case where vehicle control unit 11 implements the vehicle control to settle the mood of the driver, the driving state detecting unit 12 may determine whether the above-mentioned dangerous driving has continued or deteriorated for a predetermined time, and output the determination result to the vehicle control unit 11.

Further, when it is determined that the dangerous driving is not detected or included, the driving state detecting unit 12 may determine whether the change amount of the acceleration of the vehicle deviates from the predetermined change amount and output the determination result to the vehicle control unit 11.

The driving state detecting unit 12 can determine the dangerous driving of the above-mentioned (1) to (4) based on the learned model previously learned by the machine learning or a predetermined rule.

When using the learned model, the input data is, for example, image data around the vehicle, sensor data around the vehicle. Then, the output data is, for example, the presence or absence of dangerous driving of the above-mentioned (1) to (4).

The method of constructing the learned model used in the driving state detecting unit 12 is not particularly limited, and various machine learning methods such as deep learning using a neural network, a support vector machine, a decision tree, a simple Bayesian, and a k-neighborhood method may be used.

The emotion estimating unit 13 estimates the emotion of the driver. The emotion estimating unit 13 estimates the emotion of the driver based on the detection data (image data, biological data) by the sensor group 30. The emotion of the driver estimated by the emotion estimating unit 13 specifically indicates whether the mood of the driver is elevated (high). Further, the estimation of the emotion of the driver by the emotion estimating unit 13 is repeatedly executed for each predetermined control period.

The determination of the presence or absence of elevation of the driver's mood by the emotion estimating unit 13 includes acquiring sensor data from a sensor group 30 that observes the driver's condition, and estimating the driver's mood from the acquired sensor data using a trained machine learning model. The determination of the presence or absence of elevation of the mood of the driver by the emotion estimating unit 13 includes determining whether the mood of the driver is elevated according to the result of the above-described estimation.

When it is determined that the dangerous driving is included by the driving state detecting unit 12, the emotion estimating unit 13 acquires the image data of the driver from the camera among the sensor groups 30, for example, as illustrated in FIG. 2. Then, the emotion estimating unit 13 estimates the emotion of the driver based on the acquired image data. In this case, the emotion estimating unit 13 determines whether there is an elevation of the mood of the driver based on, for example, an expression of the driver included in the image data, and outputs the determination result to the vehicle control unit 11.

Further, the emotion estimating unit 13, when it is determined that the dangerous driving is included by the driving state detecting unit 12, acquires the biometric data of the driver from the biometric sensor of the sensor group 30, for example, as illustrated in FIG. 2. Then, the emotion estimating unit 13 estimates the emotion of the driver based on the acquired biological data. In this case, the emotion estimating unit 13 determines the presence or absence of elevation of the mood of the driver based on, for example, the body temperature, heart rate, pulse, blood pressure, EEG, and the like of the driver included in the biological data, and outputs the determination result to the vehicle control unit 11.

In addition, when the vehicle control unit 11 implements the vehicle control for settling the mood of the driver, the emotion estimating unit 13 determines whether the mood of the driver is accommodated and outputs the determination result to the vehicle control unit 11.

In addition, when the driving state detecting unit 12 determines that the dangerous driving is not included, the emotion estimating unit 13 may determine whether the driver's mood is elevated, and output the determination result to the vehicle control unit 11.

The emotion estimating unit 13 can perform the emotion estimation described above on the basis of the learned model previously learned by machine learning. When using the learned model, the input data is, for example, the image data of the driver, the biomedical data of the driver. Then, the output data is, for example, the presence or absence of elevation of the mood of the driver.

The method of constructing the learned model used in the emotion estimating unit 13 is not particularly limited, and various machine learning methods such as deep learning using a neural network, a support vector machine, a decision tree, a simple Bayesian, and a k-neighborhood method can be used.

The storage unit 20 is realized by a recording medium such as a Erasable Programmable ROM (EPROM), a hard disk drive (Hard Disk Drive: HDD), and a removable medium. The removable media includes disc recording media such as, for example, a Universal Serial Bus (USB) memory, a Compact Disc (CD), a Digital Versatile Disc (DVD), and a Blu-ray (registered trademark) Disc (BD).

The storage unit 20 can store an operating system (Operating System: OS), various programs, various tables, various databases, etc. Further, the storage unit 20, for example, the detection result in the driving state detecting unit 12, the estimation result in the emotion estimating unit 13 may be stored. The storage unit 20 may store a machine-learned model used in the vehicle control unit 11, the driving state detecting unit 12, and the emotion estimating unit 13.

The sensor group 30 acquires data for detecting the situation around the driver and the vehicle. The sensor group 30 includes a camera for photographing an image of the driver and the periphery of the vehicle, a temperature sensor and an infrared sensor for detecting the state of the driver, a biological sensor for acquiring the biological data of the driver, and an onboard sensor for detecting the state of the periphery of the vehicle. As the biological sensor, for example, a temperature sensor, a heart rate sensor, a pulse sensor, a blood pressure sensor, a EEG sensor, and the like. Further, examples of the on-board sensor include millimeter-wave sensors, infrared sensors, laser sensors, 3D-LiDAR, GPS sensors, vehicle speed sensors, acceleration sensors, and the like.

Vehicle Control Method

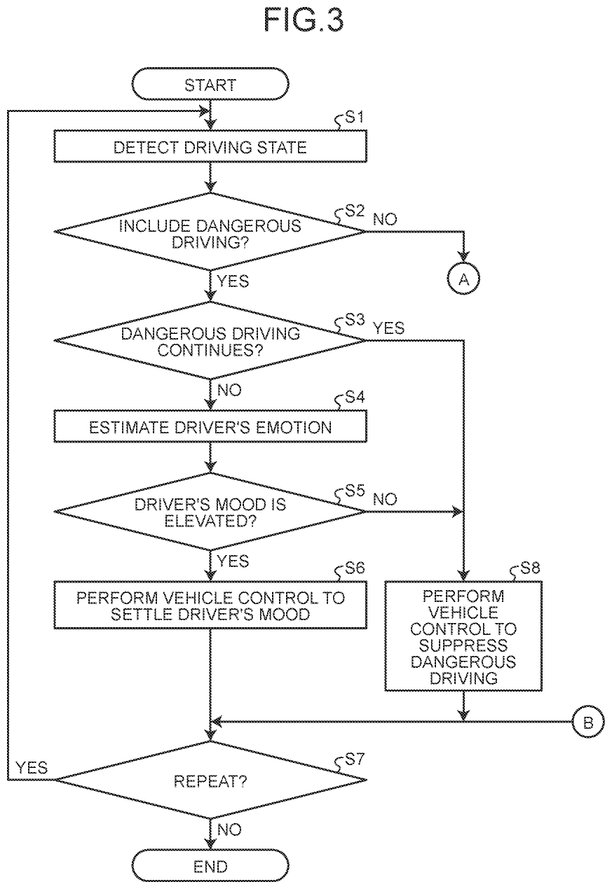

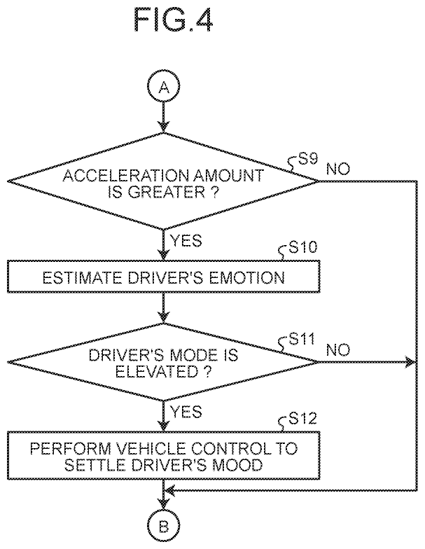

An example of a processing procedure of a vehicle control method in which the vehicle control apparatus according to the embodiment executes will be described with reference to FIGS. 3 and 4.

First, the driving state detecting unit 12 detects the driving state of the vehicle based on the image data or sensor data around the vehicle as illustrated in FIG. 3 (step S1). Subsequently, the driving state detecting unit 12 determines whether a predetermined dangerous operation is included in the detected operating state (step S2).

In step S2, if it is determined that the dangerous operation is included (Yes in step S2), the driving state detecting unit 12 determines whether the dangerous operation is continued (step S3). In step S3, if it is determined that the dangerous driving is not continued (No in step S3), the emotion estimating unit 13 estimates the emotion of the driver based on the image data or the biological data of the driver (step S4). Subsequently, the emotion estimating unit 13 determines whether there is an elevation of the mood of the driver (step S5).

In step S5, when it is determined that there is an elevation of the mood of the driver (Yes in step S5), the vehicle control unit 11 executes the vehicle control to settle the mood of the driver (step S6). Subsequently, the vehicle control unit 11 determines whether to repeat the steps S1 to S6 (step S7), and when it is determined to repeat (Yes in step S7) returns to the step S1, and when it is determined not to repeat (No in step S7) completes the present process.

In step S3, if it is determined that the dangerous driving is continued (Yes in step S3), the vehicle control unit 11 executes the vehicle control to suppress the dangerous driving (step S8), and the process proceeds to step S7. Further, in step S5, when it is determined that there is no elevation of the mood of the driver (No in step S5), the vehicle control unit 11 executes the vehicle control to suppress the dangerous driving (step S8), and the process proceeds to step S7.

In step S2, if it is determined that the dangerous driving is not included (No in step S2), the vehicle control unit 11, as illustrated in FIG. 4, the change amount of the acceleration of the vehicle to determine whether deviates from a predetermined change amount (step S9).

In step S9, when it is determined that the change amount of the acceleration of the vehicle deviates from the predetermined change amount (Yes in step S9), the emotion estimating unit 13 estimates the emotion of the driver based on the image data or the biological data of the driver (S10 step). Subsequently, the emotion estimating unit 13 determines whether there is an elevation of the mood of the driver (S11 in steps).

In step S11, when it is determined that there is an elevation of the mood of the driver (Yes in step S11), the vehicle control unit 11 executes the vehicle control to settle the mood of the driver (step S12), and the process proceeds to step 37.

In step S9, when it is determined that the change amount of the acceleration of the vehicle does not deviate from the predetermined change amount (No in step S9), the vehicle control unit 11 proceeds to step S7. Further, in step S11, when it is determined that there is no elevation of the mood of the driver (No in step S11), the vehicle control unit 11 proceeds to step S7.

According to the vehicle controller and the vehicle control program stored in the recording medium according to the embodiment described above, by performing the vehicle control to settle the mood of the driver when the mood of the driver is elevated, it is possible to shift to a safe driving state.

Further effects and variations can be readily derived by one skilled in the art. Thus, the broader aspects of the disclosure are not limited to the specific details and representative embodiments represented and described above. Accordingly, various changes may be made without departing from the spirit or scope of the overall inventive concept defined by the appended claims and their equivalents.

According to the present disclosure, it is possible to shift to a safe driving state by performing vehicle control to allow the mood of the driver to settle when the mood of the driver is elevated.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle controller for a vehicle comprising a processor, the processor being configured to:
detect a driving state of the vehicle;
determine whether a predetermined dangerous driving is included in the detected driving state;
determine, when determining that the predetermined dangerous driving is included in the detected driving state, whether a mood of a driver of the vehicle is elevated; and
perform, when determining that the mood of the driver is elevated, vehicle control to settle the mood of the driver.

2. The vehicle controller for a vehicle according to claim 1, wherein the processor is further configured to:
determine, when the vehicle control to settle the mood of the driver is performed, whether the dangerous driving continues or deteriorates for a predetermined time, and
perform, when determining that the dangerous driving continues or deteriorates for the predetermined time, vehicle control intervening in an vehicle operation of the driver.

3. The vehicle controller for a vehicle according to claim 1, wherein whether the mood of the driver is elevated is determined by:
acquiring sensor data from a sensor observing a state of the driver,
using a trained machine learning model to estimate the mood of the driver based on the acquired sensor data, and
determining whether the mood of the driver is elevated on a basis of a result of the estimation.

4. The vehicle controller for a vehicle according to claim 1, wherein the processor is further configured to:
determine, when determining that the dangerous driving is not included, whether an amount of change in acceleration of the vehicle is deviated from a predetermined change amount based on the detected driving state,
determine, when determining that the amount of change in acceleration of the vehicle is deviated from the predetermined change amount, whether the mood of the driver of the vehicle is elevated, and
perform, when determining that the mood of the driver of the vehicle is elevated, vehicle control to settle the mood of the driver.

5. A non-transitory computer-readable recording medium storing a program for causing a processor of a vehicle controller to:
detect a driving state of the vehicle;
determine whether a predetermined dangerous operation is included in the detected driving state;
determine, when determining that the predetermined dangerous operation is included in the detected driving state, whether a mood of a driver of the vehicle is elevated; and
perform, when determining that the mood of the driver is elevated, vehicle control to settle the mood of the driver.
